(19) United States
(12) Patent Application Publication
(10) Pub. No.: US 2011/0229609 A1
(43) Pub. Date: Sep. 22, 2011

(54) TOY-LIKE PET FOOD CAPABLE OF CLEANING ORAL CAVITY

(76) Inventor: YI CHIH LIN, Jia Yi Hsien (TW)

(21) Appl. No.: 12/728,277

(22) Filed: Mar. 22, 2010

(51) Int. Cl. A23K 1/10; A23K 1/18

(52) U.S. Cl. 426/104

(57) ABSTRACT

A toy-like pet food capable of cleaning oral comprises: a biting body made of cow leather; at least one meat sheet made of meat sauce; the at least one meat sheet is placed upon the biting body and the biting body is curled as a winding structure; two ends of the winding structure are tied as two knots, respectively; and the tied winding structure are dried so as to form as a hard structure for cleaning oral cavity of a pet; and wherein the meat sheet is formed with dried meat powders which is compressed as a sheet and is baked and dried from meat powders. The pet food can be provided to a pet. Since the biting body has hard, it provides the function of cleaning the oral cavity; the meat sheet embedded in the biting body will emit fragrant odor for a long period.

### FIELD OF THE INVENTION

The present invention relates to pet foods, and in particular to a toy-like pet food capable of cleaning oral cavities, wherein the pet food can be provided to a pet; the pet will bite the food. Since the biting body has a hard structure, it can provide the function of cleaning the oral cavity; the meat sheet embedded in the biting body will emit fragrant odor with a long period; and this will induce the interest of the biting action of the bit.

### BACKGROUND OF THE INVENTION

In raising pets, it is necessary to clean the oral cavity of the pet in a pet hospital. Generally, the pet doctor will send some tools for cleaning oral cavity to clean the pet's oral cavity.

For example, for dogs, the cleaning tool for cleaning the oral cavity is a bone-like object which has a bar like structure enclosed by a layer of meat sauce. Two ends of the bar like structure are exposed from the meat sauce layer. When the meat sauce is eaten wholly so that only the bone-like structure is left. Since at this moment, the bone like structure has no odor and thus the dog will have no interest to the cleaning tool. As a result, the effect of cleaning the oral cavity and teeth can not be achieved.

Moreover, there is an oral cavity cleaning tool for pets which is made of meat sauce. However since the meat sauce is not suitable for cleaning the oral cavity. Thus its effect is not better than the former one.

### SUMMARY OF THE INVENTION

Accordingly, the primary object of the present invention is to provide a toy-like pet food capable of cleaning oral, wherein the pet food can be provided to a pet; the pet will bite the food. Since the biting body has a hard structure to provide the function of cleaning the oral cavity; the meat sheet embedded in the biting body will emit fragrant odor for a long period; and this will induce the interest of the biting action of the bit.

To achieve above objects, the present invention provides a toy-like pet food capable of cleaning oral, comprising: a biting body made of cow leather; at least one meat sheet made of meat sauce; the at least one meat sheet is placed upon the biting body and the biting body is curled as a winding structure; two ends of the winding structure are tied as two knots, respectively; and the tied winding structure are dried so as to form as a hard structure for cleaning oral cavity of a pet; and wherein the meat sheet is formed with dried meat powders which is compressed as a sheet and is baked and dried from meat powders.

The various objects and advantages of the present invention will be more readily understood from the following detailed description when read in conjunction with the appended drawing.

### BRIEF DESCRIPTION OF THE DRAWINGS

FIG. 1 is a perspective view of the toy-like pet food capable of cleaning oral of the present invention.

FIG. 2 is a front view of the toy-like pet food capable of cleaning oral of the present invention.

FIG. 3 is a lateral cross sectional view of the toy-like pet food capable of cleaning oral of the present invention.

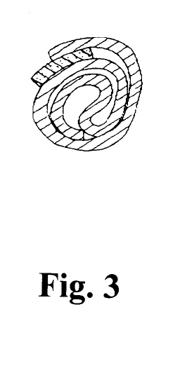

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

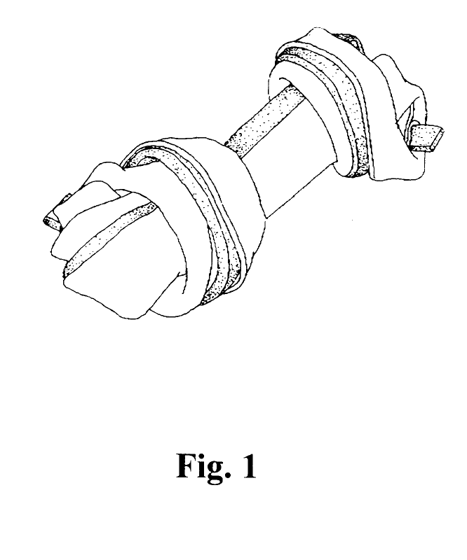

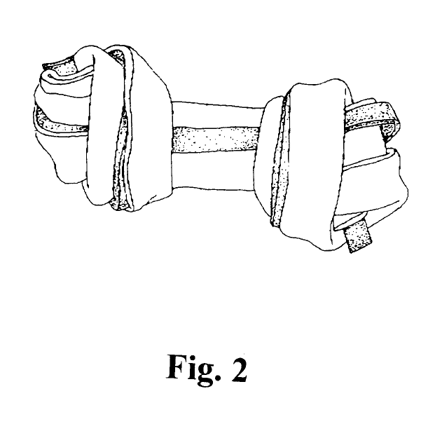

With reference to FIGS. 1 and 2, the toy-like pet food capable of cleaning oral cavity according to the present invention is illustrated. The pet food includes the following elements.

A biting body 1 is made of cow leather.

At least one meat sheet 2 made of meat sauce. The meat is selected from at least one of meats of chickens, ducks, gooses, pork, beefs, and mutton. The meat sauce is compressed as a meat sheet.

In the manufacturing process, the meat is firstly made into powders, and then the meat powders are compressed as sheets. Then the meat sheets are baked and dried as dried meat sheets.

The at least one meat sheet is placed upon the biting body 1. Then the biting body 1 is curled as a winding structure. Two ends of the winding structure are tied as two knots 3, respectively. Then the tied winding structure are dried so as to form as a hard structure for cleaning oral cavity of a pet.

In using, the pet food can be provided to a pet. The pet will bite the food. Since the biting body 1 has a hard structure, it can provide the function of cleaning the oral cavity. The meat sheet 2 embedded in the biting body 1 will emit fragrant odor for a long period. Thus this will induce the interest of the biting action to the pet biting the biting body.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A toy-like pet food capable of cleaning oral, comprising:
a biting body made of cow leather;
at least one meat sheet made of meat sauce; the at least one meat sheet is placed upon the biting body and the biting body is curled as a winding structure; two ends of the winding structure are tied as two knots, respectively; and the tied winding structure are dried so as to form as a hard structure for cleaning oral cavity of a pet; and
wherein the meat sheet is formed with dried meat powders which is compressed as a sheet and is baked and dried from the meat powders; and
wherein the pet food can be provided to a pet. Since the biting body has a hard structure, it provides the function of cleaning the oral cavity; the meat sheet embedded in the biting body will emit fragrant odor for a long period; and this will induce the interest of the biting action of the bit.

2. The toy-like pet food capable of cleaning oral as claimed in claim 1, wherein the meat is selected from at least one of meats of chickens, ducks, gooses, pork, beefs, and mutton.

3. The toy-like pet food capable of cleaning oral as claimed in claim 1, wherein the meat sheet is a duck sheet.

4. The toy-like pet food capable of cleaning oral as claimed in claim 1, wherein the meat sheet is a goose sheet.

5. The toy-like pet food capable of cleaning oral as claimed in claim 1, wherein the meat sheet is a pork sheet.

6. The toy-like pet food capable of cleaning oral as claimed in claim 1, wherein the meat sheet is a mutton sheet.
